(19) United States
(12) Patent Application Publication
(10) Pub. No.: US 2004/0133783 A1
(43) Pub. Date: Jul. 8, 2004

(54) Method for non repudiation using cryptographic signatures in small devices

(76) Inventors: Sverre Tonnesland, Oslo (NO); Pal Bjolseth, Oslo (NO)

Correspondence Address: ERICSSON INC., 6300 LEGACY DRIVE, M/S EVR C11, PLANO, TX, 75024, US

(21) Appl. No.: 10/475,391

(22) PCT Filed: Apr. 12, 2002
(86) PCT No.: PCT/SE02/00737

(30) Foreign Application Priority Data
Apr. 25, 2001 (NO) 20012029

(51) Int. Cl. H04L 9/00

(52) U.S. Cl. 713/176

(57) ABSTRACT

A method for providing electronical signing of data using a limited signing device is disclosed. This is achieved by extracting a part of the data in a signature using system, compiling it to a proper protocol used by the signing device and transferring it to said signing device together with a hash of the data. The user of the signing device will then be presented to the compiled part of the data which is adjusted according to the limitations of the signing sevice and which is understandable for the user. The user may then electronically sign the data by means of the signing device using an appropriate signature algorithm. A correct hash proves that the user really signs the intended data, even if he is presented only to an understandable and signing device adjusted part of the data. The resulting signature is returned to the signature using system, and the original data, the part of the data, the hash and the signature are sent to a signature receiving system for processing, verification, storing, etc.

### FIELD OF THE INVENTION

The invention is related to networked computing devices, especially when cryptographic signing is being used to achieve non-repudiation, access control, user verification, etc.

### BACKGROUND OF THE INVENTION

Many kinds of applications, e.g. electronic commerce (e-commerce) or mobile commerce (m-commerce), require the ability to provide persistent proof that someone has authorized a transaction. Also, signing of electronic material, such as assignments, business reports and different kinds of forms is expected to be customary in the near future.

E-commerce and m-commerce are rapidly growing business areas, and both public and private administrations now seem to make adjustments for allowing electronic signing. However, a breakthrough for electronic signing is depended of secure, tamper-proof and simple procedures and solutions. The signing part has to be sure that what he/she is signing is the same as received at the receiving part. The receiving part must be sure of that the signing part is who he/she says he/she is. Further, the signing should be simple without requiring any technical knowledge from the user, and preferably feasible independent of time and localization.

Cryptographic signatures are being used in a multitude of areas. This typically involves in addition to the user, being the owner of the cryptographic signing device, a signature using system and a signature receiving system. The signature using system asks the user to perform a cryptographic signature on the data presented. The user signs and returns the signature back to the signature using system. The signature using system can pass the data that was signed and the signature to the signature receiving system. The signature receiving system has a cryptographically binding relation between what the signature using system presented to the user for signing, and what the user signed.

The PKI (Public Key Infrastructure) is a widely used system for cryptographic signing and authentication, well known by persons skilled in the art. A trusted part in a PKI system issues pairs of electronic keys. The pair consists of one private key and one public key. The private key is only known by the user (or the user's signing device), but the public key may be known by any second part indented to receive signed data from a user. In the user's device, the object to be signed and the private key are inputs to some algorithm outputting the object in a signed condition. At the receiving part, the signed object and the public key are inputs to some other algorithm, extracting the original object from the signed object. The object will be correctly extracted only if the private key signed it. Consequently, the receiving part can be sure that the object was signed by that specific user when utilizing this user's public key for extraction signed the object.

Many electronic devices already support cryptographic signing. One example is a PC with an Internet browser installed. The browser may have one or more certificates containing public keys issued from one or more trusted parts or so-called Certification Authorities (CA).

One problem with this is that a PC usually is bound to one fixed location, and/or it is too big to be carried around everywhere. However, the need for signing materials is not limited to places in which PCs are localized or may be carried.

Further, a PC that is being online all the time or for longer time periods is very vulnerable for data sniffing, and there might be a risk for intruders grabbing the private keys. For security reasons, a user might want to utilize his/hers personal signing device for signing the material presented on the PC.

The solution of the above-mentioned problems might be small portable devices such as cellular phones. “WMLScript Language Specification”, WAP Forum describes an implementation of a function allowing WAP phones executing cryptographic signing. The WAP phone requests the user to sign a string of text by entering e.g. a PIN code for the device to cryptographically sign the string.

However, such devices, e.g. cellular phones, are characterized by being memory and processing capacity limited and the cryptographic signing function is accessible through a defined and limited interface.

Further, small devices like cellular phones normally do not have a graphical screen or relatively large programmes like PowerPoint and Word installed.

The problems then occur when the data to be signed is too big to be presented to the user, or in a format that is not understandable to the user or not compatible to the signing device. The above-mentioned WAP specification, however, assumes that the data is understandable and small enough to be presented on hardware and display limited devices.

### SUMMARY OF THE INVENTION

The main object of the present invention is to overcome the above-identified problems and provide non-repudiation between a user, a signature using system and a signature receiving system. This is achieved by a method defined by the enclosed claim 1.

More specifically, the present invention provides a method for digitally signing of data using a signing device by extracting a part of the data in a signature using system, compiling it to a proper protocol used by the signing device and transferring it to said signing device together with a hash-code of the data. The user of the signing device will then be presented to the compiled part of the data, which is adjusted according to the limitations of the signing device and is understandable for the user. The user may then electronically sign the data by means of the signing device using an appropriate signature algorithm. A correct hash-code proves that the user really signs the intended data, even if he is presented only to an understandable and adjusted part of the data. The resulting signature is returned to the signature using system, and the original data, the part of the data, the hash-code and the signature are sent to a signature receiving system for processing, verification, storing, etc.

The present invention allows using small hardware and processor limited signing devices, e.g. mobile phones, for signing data being too large for the signing device.

### BRIEF DESCRIPTION OF THE DRAWINGS

FIG. 1 illustrates the problem of signing non-readable text on a small device.

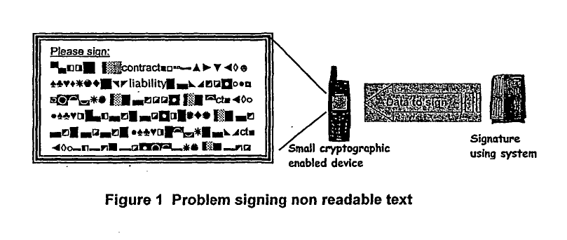

FIG. 2 is a flow chart showing the data flow in an embodiment according to the present invention.

FIG. 3 shows how the data may be transferred between elements involved in an embodiment according to the present invention.

FIG. 4 shows an example of the data flow in a push signing request using a WAP 1.2 enabled mobile device, in which HTTP is used between a signature using and a signature receiving system.

FIG. 5 is a view of how an extracted text from an original object that is to be signed may look like.

### PREFERRED EMBODIMENTS OF THE PRESENT INVENTION

In the following, a preferred embodiment of the present invention is described. Note that this embodiment is discussed for illustration purposes only, and does not limit the invention as it is defined in the enclosed claim 1.

The embodiment described provides a flexible way to accomplish cryptographic binding between a user and a set of data that is unreadable to human beings in its original form or too large to be presented to the user for signing. It is partly described in a protocol syntax with reference to the above mentioned drawings.

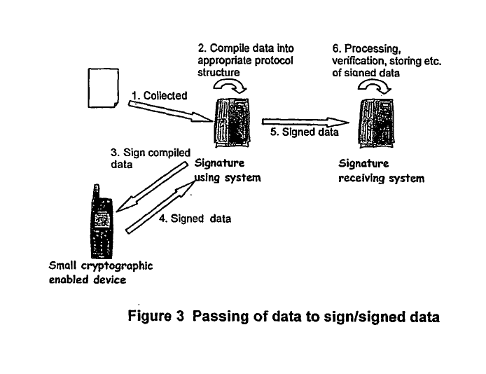

FIG. 3 illustrates a push scenario, where the signature using system connects to the small cryptographic device and conveys the signature request. In a pull scenario, the small cryptographic device connects to the signature using system and asks for the data to be signed.

The signature using system and signature receiving system are logical entities in a computing network. They might reside in the same network component or they might be separated from each other as in the exemplification above where the signature using system is the user's PC.

The signature using system compiles (2) a collected (1) message in such a way that it can be presented and understood by the user. The signature using system may be any data system, node or computer that is being in possession of the entire collected data that is to be signed. For example, the signature using system may be the user's PC having received a document requiring a signature.

The compiled data is then transferred (3) to a small cryptographic enabled device of the user, e.g. a WAP phone. The user signs this message using an appropriate signature algorithm. The user may accomplish the signing by entering a certain signing PIN code.

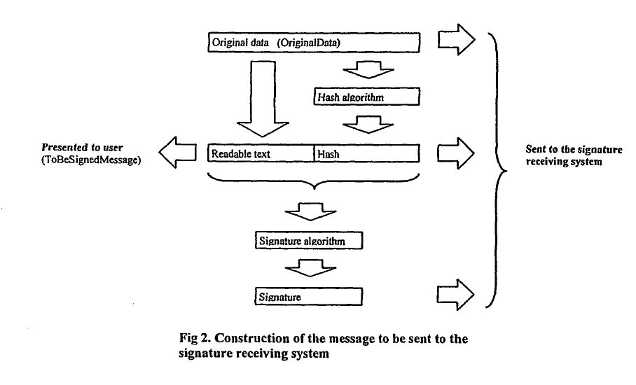

The result is sent back (4) to the signature using system, and compiled into a message to be sent (5) to the signature receiving system containing at least (ref. FIG. 2):

1) OriginalData and hash-code algorithm identifier.

2) ToBeSignedMessage and the signature algorithm identifier and the signature.

OriginalData is the original data that was to be signed. This can be documents, protocol structures, contracts, etc. The present invention enables a cryptographic binding between this data and the user of the device.

The ToBeSignedMessage is the message presented for signing. It is subject to the limitations in the device regarding length of the data to be signed. It has two parts:

1) A part that the user of the device will understand and that is part of the OriginalData. Methods for extracting readable information from the OriginalData can be defined depending on its nature.

If the nature of the OriginalData is such that no readable data can be extracted, the signature using system generates a suitable text for presentation to the user.

The signature receiving system must know the rule used for selecting this text.

If the device is used for signing e.g. large documents containing pictures etc., this field can contain dynamic information about the document. Examples are: Doc name=This years budget, Doc no=1FR2, Doc rev=A2, Doc size=2345, Pic1 format=jpeg, Pic1 size=123, Table1 size=234.

If the device is used for signing a picture or music file, then example information could be: Title=Dance music vol1, Format=mp3, Size=2345, Length=1.16

2) A part that is not understandable to the user of the device. This is the hash-code of the OriginalData. The presence of the hash-code is the real binding between the original data and the signing. It guarantees that the user really signs the original data, as he/she knows it, and not just the readable text. If the original data is exposed to only a small change before hashing, the hash-code code will look completely different than expected, and the cryptographic enabled device of the user will know that the data has been changed, and then reject it.

This solution presents to the user of the device an understandable message of which information is to be signed. It is also flexible in providing different signature receiving systems with tailor-made data authenticating both the signature-using system and the user of the device.

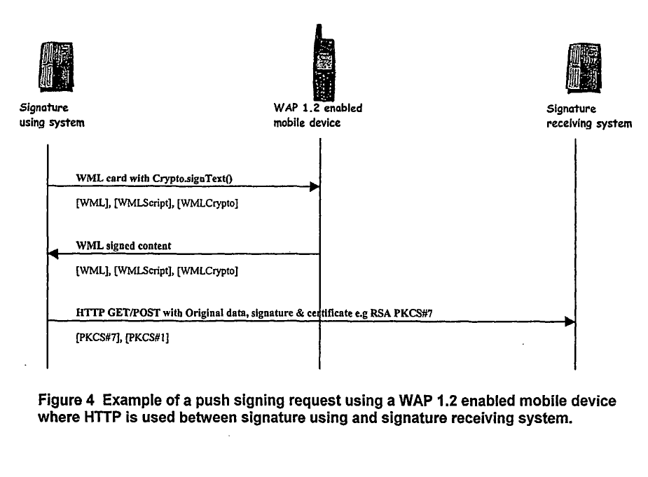

The signing procedure and the data collection can be implemented using different kinds of protocols. FIG. 4 shows an example of a push-signing request where WML Script is being used in the communication with a WAP 1.2 enabled mobile device during the signing procedure, and where HTTP is used between the signature using and signature receiving systems. However, other scripts, protocols and signing devices can be used for these purposes (e.g. LDAP [LDAP], SQL [SQL], I-MODE adapted devices and scripts).

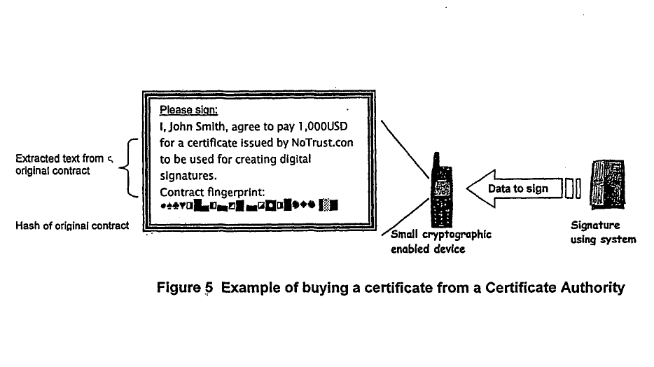

Finally, FIG. 5 views an example of how the compiled understandable data (referred to as ToBeSignedMessage in FIG. 2 and compiled data in FIG. 3) can appear for the user on the display of the cryptographic enabled device.

The main advantage of the present invention is that it makes the user able to understand what he/she is signing even on small and hardware limited devices. This increases a signing part's freedom of movement, as he/she may use portable cryptographic enabled devices even for large amounts of data.

A further advantage is that only a small amount of the data to be signed is sent to and from the device as well as processed by the device, making the procedure faster and not limited by neither narrow transfer capacity nor low processor capability.

Very large unstructured pieces of information may then be broken down into a defined message agreed upon structure, verified and then signed with the user's personal signing device.

Further, the present invention makes it possible to use a small device to sign e.g. documents with graphical content even if the device is not equipped with a graphical screen.

Still another advantage of the present invention is that it allows the user's private key to be separated from the signature using system to which generally external networks are connected (e.g. PC-s to the Internet). The risk of intruders grabbing private signing keys is consequently reduced.

Still another advantage of the invention is that no adjustments in custom signing devices such as WAP 1.2 enabled mobile devices are required. The sign applications already implemented may be utilized.

The invention is suitable for the WAP 1.2 signText( ) functionality or a cryptographic sign application implemented using the SIM Application Toolkit (SAT), and this is used in the examples here described. However, other embodiments applicable in any scenarios where data has to be signed and understood by a human using a small cryptographic device being within the scope of the invention as defined by the following claims may be utilized.

### REFERENCES

[PKCS#1] RSA Cryptography Standard

http://www.rsasecurity.com/rsalabs/pkcs/

[PKCS#7] Cryptographic Message Syntax Standard

http://www.rsasecurity.com/rsalabs/pkcs/

[WAPArch] “WAP Architecture Specification”

http://www.wapforum.org/what/technical.htm

[WML] “Wireless Markup Language”, WAP Forum

http://www.wapforum.org/what/technical.htm

[WMLScript] “WMLScript Language Specification”, WAP Forum

http://www.wapforum.org/what/technical.htm

[WMLCrypto] “WMLScript Crypto Library Specification”, WAP Forum

http://www.wapforum.org/what/technical.htm

[HTTP] HyperText Transfer Protocol

RFC 2069

http://www.ietf.org/rfc/rfc2068

[LDAP] Lightweight Directory Access Protocol

RFC 2559

http://www.ietf.org/rfc/rfc2559

[SQL] Structured Query Language

http://www.sql.org

1. A method for electronically and/or digitally signing of data using a first small portable signing device utilizing an electronic signing system comprising the following steps:
a) extracting a part of said data in a second signing device,
c) hashing said data in said second signing device resulting in a hash-code of said data,
d) transferring said part of data and said hash-code to said first small portable signing device in a single request,
e) signing said request in said first small portable signing device according to said electronic signing system,
characterized in the following step subsequent to step a) and prior to step c):
b) compiling said parts of data to a format adjusted to said first small portable signing device being readable for a user thereof.

2. A method according to any of the preceding claims,
characterized in that it further includes the following step:
returning a signature as a result of said signing from the first small portable signing device to the second signing device.

3. A method according to claim 2,
characterized in that it further includes the following step:
transferring said data, request and signature from said second signing device to a third signing device.

4. A method according to any of the preceding claims,
characterized in that the first small portable signing device is a small cryptographic enabled device using a certain protocol and the second signing device is a signature using system adjusted to compile said part of data into said protocol.

5. A method according to claim 3 or 4,
characterized in that said third signing device is a signature receiving device for at least processing, verification and/or storing of signed data.

6. A method according to claim 4 or 5,
characterized in that said protocol is WAP (Wireless Application Protocol) and the first small portable signing device is a WAP enabled mobile device.

7. A method according to one of the preceding claims,
characterized in that said electronic signing system is using private/public keys.

8. A method according to one of the preceding claims,
characterized in that said data is a document, a form, an assignment, or a transaction.

9. A method according to one of the claims 6-8,
characterized in that the signing is executed by means of the WAP 1.2 signText( ) functionality.

10. A method according to one of the claims 6-9,
characterized in that the signing is executed by means of a cryptographic sign application implemented using the SIM Application Toolkit (SAT).
